(19) United States
(12) Patent Application Publication
(10) Pub. No.: US 2009/0061283 A1
(43) Pub. Date: Mar. 5, 2009

(54) CARTRIDGE FOR FUEL CELL AND FUEL CELL

(75) Inventors: Kensuke YOSHIDA, Kawasaki (JP); Hiroaki YOSHIDA, Kawasaki (JP); Fumio TAKEI, Kawasaki (JP); Akio YANO, Setagaya (JP); Yoichi TAKASU, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/236,151

(22) Filed: Sep. 23, 2008

Related U.S. Application Data
(63) Continuation of application No. PCT/JP2006/306017, filed on Mar. 24, 2006.

(51) Int. Cl. H01M 2/14

(52) U.S. Cl. 429/38

(57) ABSTRACT

A cartridge for fuel cell for supplying a fuel to a fuel cell, the cartridge for fuel cell including: a cartridge case 32 having a plurality of holes 34 formed at least in one side 32a; a fuel vaporization stabilization layer 38 formed on the side with said plurality of holes 34 formed in inside the cartridge case 32; and a fuel impregnation material 36 sealed inside the cartridge case 32.

### CROSS-REFERENCE TO RELATED APPLICATION

This application is a Continuation of International Application No. PCT/JP2006/306017, with an international filing date of Mar. 24, 2006, which designating the United States of America, the entire contents of which are incorporated herein by reference.

### FIELD

The embodiment discussed herein is directed to a cartridge for fuel cell and a fuel cell.

### BACKGROUND

The recent portable information apparatuses are further increasingly downsized and lightened and have the speed and achievements, etc. improved as the semiconductor technique and the communication technique are developed. Accompanying this, the cells which are the electric sources of the portable information apparatuses are also downsized and lightened and has the capacity increased.

The recent most general drive electric source of the portable information apparatuses is lithium ion cell. The lithium ion cell realized high drive voltages and cell capacities at the time when the lithium ion cell was put to practical uses, and has had the achievements improved as the portable information apparatuses have been developed.

However, the lithium ion cell is limited in improving the achievements and cannot always sufficiently satisfy further requirements as the drive electric source of the portable information apparatuses.

Under such circumstances, as a new energy device taking over the lithium ion cell, fuel cells are noted. In the fuel cell, a fuel is supplied to the cathode to produce electrons and protons, and the produced protons are reacted with oxygen supplied to the anode to thereby generate power.

A fuel of the fuel cell, specifically methanol is stored in a cartridge for fuel cell disposed separate from the power generation part. For the fuel cell to continuously generate power, it is necessary to continuously supply a fuel stored in the cartridge for fuel cell to the power generation part.

As a technique for supplying a fuel stored in the cartridge for fuel cell to the power generation part, the technique for supplying a fuel vaporized in the cartridge for fuel cell to the power generation part is proposed.

### SUMMARY

According to an aspect of the embodiment, a cartridge for fuel cell for supplying a fuel to a fuel cell, the cartridge for fuel cell comprising: a cartridge case having a plurality of holes formed at least in one side; a fuel vaporization stabilization layer formed on the side with said plurality of holes formed in inside the cartridge case; and a fuel impregnation material sealed inside the cartridge case.

According to an aspect of the embodiment, a fuel cell comprising a power generation part including a fuel electrode, a solid electrolytic layer and an air electrode, and a slot provided in the power generation part on the side of the fuel electrode, for removably receiving a cartridge for fuel cell which discharges vaporized fuel, the cartridge for fuel cell comprising a cartridge case having a plurality of holes formed in one side, a fuel vaporization stabilization layer formed on the side with said plurality of holes formed in inside the cartridge case, and a fuel impregnation material sealed inside the cartridge case.

Additional objects and advantages of the embodiment will be set forth in part in the description which follows, and in part will be obvious from the description, or may be learned by practice of the embodiment. The object and advantages of the embodiment will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF DRAWINGS

FIGS. 1A to 1C are sectional views of the cartridge for fuel cell (Part 1) according to one embodiment;

FIGS. 2A to 2C are sectional views of the cartridge for fuel cell (Part 2) according to the embodiment;

FIGS. 3A to 3C are sectional views of the proposed cartridge for fuel cell;

FIG. 4 is a sectional view of the fuel cell system according to the embodiment, which illustrates the basic structure;

FIGS. 5A and 5B are a sectional view and a plan view (Part 1) of the cartridge for fuel cell according to the embodiment;

FIGS. 6A and 6B are a sectional view and a plan view (Part 2) of the cartridge for fuel cell according to the embodiment;

FIG. 7 is a method for penetrating the fuel into the fuel impregnation material of the cartridge for fuel cell (Part 1);

FIGS. 8A and 8B are views illustrating the process of mounting the cartridge for fuel cell according to the embodiment on the back of a portable telephone (Part 1);

FIGS. 9A and 9B are views illustrating the process of mounting the cartridge for fuel cell according to the embodiment on the back of a portable telephone (Part 2);

FIGS. 10A and 10B are views illustrating the process of mounting the cartridge for fuel cell according to the embodiment on the back of a portable telephone (Part 3);

FIG. 11 is a graph of the result of evaluating the cartridge for fuel cell according to the embodiment;

FIG. 12 is a view illustrating the method for penetrating the fuel into the fuel impregnation material of the cartridge for fuel cell (Part 2).

### DESCRIPTION OF EMBODIMENT

As described previously, as a technique for supplying a fuel stored in the cartridge for fuel cell to the power generation part, the technique for supplying a fuel vaporized in the cartridge for fuel cell to the power generation part is proposed. However, in the proposed technique, as a fuel in the cartridge for fuel cell is consumed, the fuel is discharged gradually in smaller quantities. Accordingly, it is difficult to maintain stable electric power by the proposed technique.

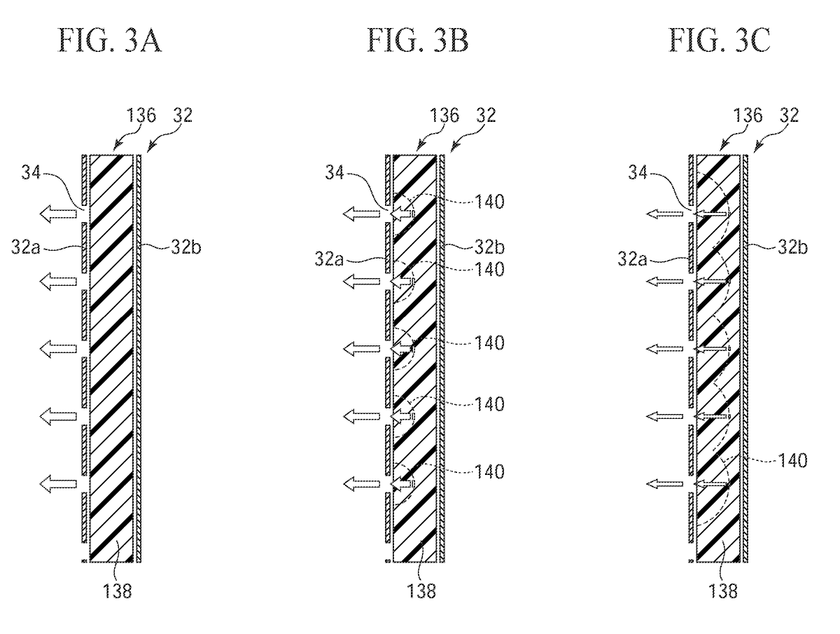

FIGS. 3A to 3C are sectional views of the proposed cartridge for fuel cell.

FIG. 3A illustrates the state that a fuel impregnation material 136 sealed in a cartridge case 32 is sufficiently impregnated with a fuel, i.e., methanol. A plurality of holes 34 are formed in one side of the cartridge case 32, and in the other side no holes are formed. As the fuel impregnation material 136, a polymer material of a strong skeleton is used. Accordingly, the fuel impregnation material 136 does not substantially change the volume between when impregnated and when not impregnated. In FIGS. 3A to 3C, the arrows indicate the discharge of the fuel from the fuel impregnation material 136.

In the state illustrated in FIG. 3A, the fuel impregnation material 136 is impregnated with the fuel 40 in a uniform concentration. In the state illustrated in FIG. 3A, where the fuel impregnation material 136 is sufficiently impregnated generally with the fuel, the fuel can be discharged in a high concentration from the cartridge for fuel cell.

FIG. 3B illustrates the state where the fuel has vaporized from the fuel impregnation material 136 to some extent. Of the fuel impregnation material 136, parts 140 located near the holes 34 have a much lower concentration of the fuel, i.e., the methanol. The concentration of the methanol in these parts 140 becomes much lower, because the vaporization of methanol is relatively quick, but the vaporization of water is relatively slow. In the parts 140, because of much water, which is relatively slow to vaporize, remains, the concentration of the methanol is much lower. In a part 138 of the fuel impregnation material 136, which is located on the side 32b where the holes 34 are not formed, the vaporization of the methanol has not substantially advanced, and the concentration of the methanol is relatively higher. Some of the methanol is supplied from the part 138, where the concentration of the methanol is relatively higher to the parts 140, where the concentration of the methanol is relative lower, but because of much water remaining there, the concentration of the methanol in the parts 140 located on the side 32a with the holes 34 formed in cannot become sufficiently higher. The parts 32a, where the methanol concentration is lower, goes on expanding into spheres centering the holes 34, and the paths for discharging the fuel in the fuel impregnation material 136 becomes longer. Accordingly, the fuel discharged from the cartridge for fuel cell in the state of FIG. 3B is less than the fuel discharged from the cartridge for fuel cell in the state of FIG. 3A.

FIG. 3C illustrates the state where the fuel has further vaporized from the fuel impregnation material 136. In FIG. 3C, the part 140 of the fuel impregnation material 136, where the concentration of the methanol is much lower, have further expanded. On the other hand, the parts 138 of the fuel impregnation material 136, where the concentration of the methanol is relatively higher, have become much smaller. The methanol is supplied to some extent from the parts 138, where the concentration of the methanol is relatively higher, to the part 140, where the concentration of the methanol is relatively lower, but because of much water remaining in the part 140 on the side of the side 32a with the holes 34 formed in, the concentration of the methanol in the part 140 located on the side of the side 32a with the holes 34 formed in cannot become higher. Furthermore, as the parts 32a, where the concentration of the methanol is lower, expands, the paths for the fuel discharge in the fuel impregnation cartridge 136 become longer. Thus, the fuel discharged from the cartridge for fuel cell in the state of FIG. 3C is less than the fuel discharged from the cartridge for fuel cell in the state of FIG. 3B.

As described above, when the fuel is penetrated in the simple fuel impregnation material 136, specifically, the fuel impregnation material 136 of a polymer material of a strong skeleton, the concentration of the fuel in the part 140 located near the holes 34 become very much lower, which makes it difficult to stably discharge the vaporized fuel.

The inventors of the present application made earnest studies and have got the idea that a fuel vaporization stabilization layer of a porous material is formed between the side with the holes formed in and the fuel impregnation material, whereby the vaporized fuel can be stably discharged. A fuel impregnation material which is able to sufficiently increase the volume when impregnated with the fuel than when not impregnated with the fuel is used, whereby the vaporized fuel can be more stably discharged.

Preferred embodiment will be explained with reference to accompanying drawings.

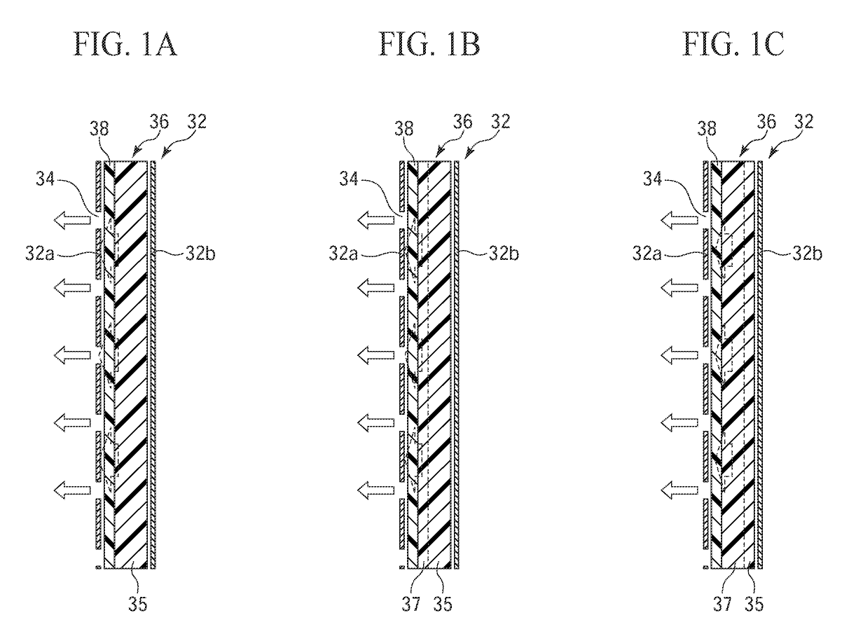

FIGS. 1A to 1C are sectional views of the cartridge case in which a fuel vaporization stabilization layer of a porous material is disposed between the side of the cartridge case with the holes formed in and the fuel impregnation material. In FIGS. 1A to 1C, the arrows indicate the discharge of the fuel from the fuel impregnation material 36.

As illustrated in FIGS. 1A to 1C, the fuel impregnation material 36 sealed in the cartridge case 32 is sufficiently impregnated with a fuel, i.e., a methanol aqueous solution. A plurality of holes 34 are formed in one side of the cartridge case 32, and no holes 34 are formed in the other side of the cartridge case 32. As the fuel impregnation material 36, a polymer material of a strong skeleton is used. Between the plural holes 34 formed in the cartridge case 32 and the fuel impregnation material 36, a porous material 38 forming the fuel vaporization stabilization layer is provided. When the fuel impregnation material 36 is located on the side of the side 32a with the holes 34 formed in, the holes 34 are closed by the fuel impregnation material 36, which makes it difficult to discharge the fuel outside. However, the holes 34 and the fuel impregnation material 36 are spaced from each other by the porous material 38, whereby a space can be defined on the side of the side 32a with the holes 34 formed in. The holes 34 can be prevented from being closed by the fuel impregnation material 36, and the fuel can be surely discharged outside.

In FIGS. 1A to 1C, the holes 34 are formed only in one side of the cartridge case 32, but the holes 34 are formed in both sides of the cartridge case 32 when one cartridge for fuel cell supplies the fuel to a plurality of power generation parts, especially when power generation parts are provided on both sides of the cartridge for fuel cell. In such case, inside the cartridge case 32, on each side of both sides with the holes 34 formed in, the fuel vaporization stabilization layer 38 of a porous material is provided, and the fuel impregnation material 36 is provided between the two fuel vaporization stabilization layer 38.

FIG. 1A illustrates the state where the fuel impregnation material 36 is sufficiently impregnated with the fuel. The fuel impregnation material 36 has the entirety 35 impregnated with a relatively high concentration of the fuel, and the fuel can be stably discharged.

FIG. 1B illustrates the state where the fuel penetrated in the fuel impregnation material 36 has been a little decreased. The fuel impregnation material 36, which is formed of a polymer material of a strong skeleton, does not change the volume when the content of the fuel is decreased. Because of the fuel vaporization stabilization layer 38 provided between the holes 34 and the fuel impregnation material 36, the fuel is consumed uniformly thickness-wise of the cartridge case 32. As illustrated in FIG. 1B, in the part 37 of the fuel impregnation material 36, where the holes 34 are formed, the concentration of the fuel is uniformly lower in the direction of the thickness of the cartridge case 32. The thickness of the part 35 sufficiently impregnated with the fuel becomes smaller than the thickness in FIG. 1A. The concentration of the fuel becomes uniformly lower in the direction of the thickness of the cartridge case 32, and the paths for the fuel discharge inside the fuel impregnation material 36 never become extremely long, as illustrated in FIG. 3B. Thus, even in the state of FIG. 1B, the fuel can be stably discharged in comparison with the fuel discharge in the state of FIG. 3B.

FIG. 1C illustrates the state where the fuel penetrated in the fuel impregnation material 36 has been further decreased. As described above, the fuel impregnation material 36, which is formed of a polymer material of a strong skeleton, does not change the volume even when an impregnation quantity of the fuel has been decreased. Because of the fuel vaporization stabilization layer 38 provided between the holes 34 and the fuel impregnation material 36, the fuel is further consumed uniformly in the direction of the thickness of the cartridge case 32. The thickness of the part 37, where the concentration of the fuel is lower, becomes thicker in comparison with that in FIG. 1B. The thickness of the part 35 sufficiently impregnated with the fuel becomes smaller in comparison with that in FIG. 1B. The fuel is discharged uniformly in the direction of the thickness of the cartridge case 32, and the paths for the fuel discharge in the fuel impregnation material 36 never become extremely long as illustrated in FIG. 3C. Thus, even in the state of FIG. 1C, the fuel can be stably discharged in comparison with the fuel discharge in the state of FIG. 3C.

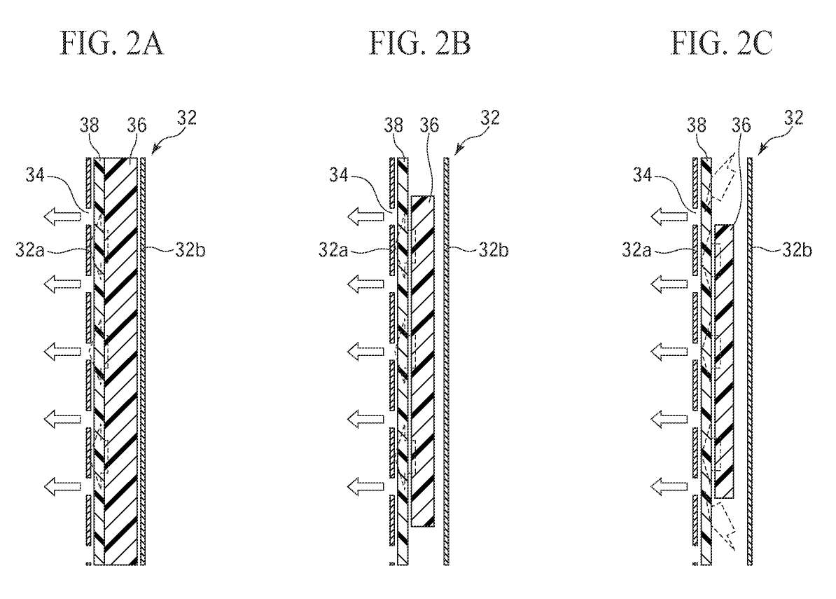

FIGS. 2A to 2C are sectional views of the cartridge case in which the fuel vaporization stabilization layer of a porous material is disposed between the side with the holes formed in and the fuel impregnation material which is able to sufficiently increase the volume when impregnated with a large amount of the fuel in comparison with the volume at the time when not impregnated with the fuel. In FIGS. 2A to 2C, the arrows indicate the discharge of the fuel from the fuel impregnation material 36.

As illustrated in FIG. 2A, the fuel impregnation material 36 sealed inside the cartridge case 32 is sufficiently impregnated with the fuel, i.e., a methanol aqueous solution. A plurality of the holes 34 are formed in one side of the cartridge case 32, and no holes are formed in other side of the cartridge case 32. As the fuel impregnation material 36, a polymer material of a flexible skeleton is used. The fuel vaporization stabilization layer 38 of a porous material is formed between the plural holes 34 of the cartridge case 32 and the fuel impregnation material 36. When the fuel impregnation material 36 is located on the side 32a with the holes 34 formed in, the holes 34 are closed by the fuel impregnation material 36, and it is difficult to discharge the fuel outside. However, the fuel vaporization stabilization layer 38 of a porous material is disposed between the holes 34 and the fuel impregnation material 36, whereby a space can be defined on the side of the side 32a with the holes 34 formed in. The holes 34 are prevented from being closed by the fuel impregnation material 36, and resultantly, the fuel can be surely discharged outside.

FIG. 2A illustrates the state where the fuel impregnation material 36 is sufficiently impregnated with the fuel. The fuel impregnation material 36, which is impregnated with a relatively high concentration of the fuel, can stably discharge the fuel.

FIG. 2B illustrates the state where the fuel penetrated in the fuel impregnation material 36 has a little decreased. The fuel impregnation material 36, which is formed on a polymer material of a flexible skeleton, decreases the volume as the content of the fuel decreases, and the concentration of the fuel penetrated in the fuel impregnation material 36 is retained in a relative high concentration. Accordingly, in the state of FIG. 2B, the fuel can be discharged stably in comparison with the fuel discharge in the states of FIG. 1B and FIG. 3B. Even when the fuel impregnation material 36 shifted due to changes of the volume of the fuel impregnation material 36, because of the presence of the fuel vaporization stabilization layer 38 between the fuel impregnation material 36 and the holes 34, the holes 34 in the cartridge case 32 are never closed by the fuel impregnation material 36.

FIG. 2C illustrates the state where the fuel penetrated in the fuel impregnation material 36 has further decreased. As described above, even when the fuel impregnation material 36, which is formed of a polymer material of a flexible skeleton, decreases the volume as the content of the fuel decreases, the concentration of the fuel penetrated in the fuel impregnation material 36 is retained in a relatively high concentration. Thus, in the state of FIG. 2C as well, the fuel can be stably discharged.

As described above, according to the present embodiment, the fuel vaporization stabilization layer 38 of a porous material is provided between a plurality of the holes 34 formed in at least one side of the cartridge case 32 and the fuel impregnation material 36, whereby the fuel vaporization stabilization layer 38 can prevent the plural holes 34 from being closed by the fuel impregnation material 36. Thus, according to the present embodiment, the cartridge for fuel cell which can stably discharge the fuel can be provided.

According to the present embodiment, the fuel vaporization stabilization layer 38 is formed, whereby even when the fuel impregnation material 36 is formed of a polymer material of a strong skeleton, the fuel is consumed uniformly in the direction of the thickness of the cartridge case 32. Thus, according to the present embodiment, even when the fuel impregnation material 36 of a polymer material of a strong skeleton is used, the paths for the fuel discharge in the fuel impregnation material 36 can be prevented from becoming extremely long, and the fuel can be stably provided.

According to the present embodiment, the fuel impregnation material 36 is formed of a material which is able to increase the volume when impregnated with a large amount of the fuel in comparison with a volume at the time when not impregnated with the fuel, whereby the volume of the fuel impregnation material 36 sufficiently decreases as the content of the fuel decreases. Thus, according to the present embodiment, even when the fuel penetrated in the fuel impregnation material 36 is consumed and decreased, the fuel penetrated in the fuel impregnation material 36 is retained in a high concentration. According to the present embodiment, the cartridge for fuel cell which can stably supply the vaporized fuel can be provided.

### One Embodiment

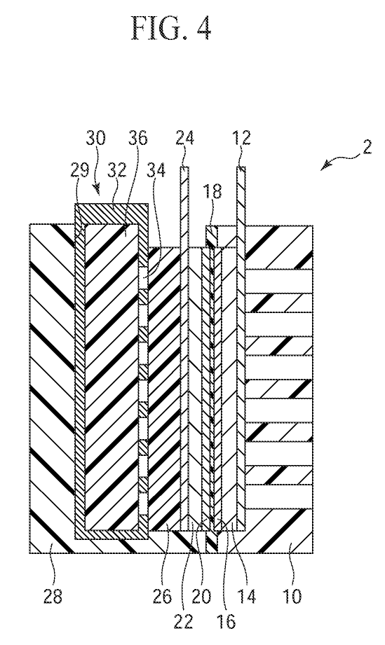

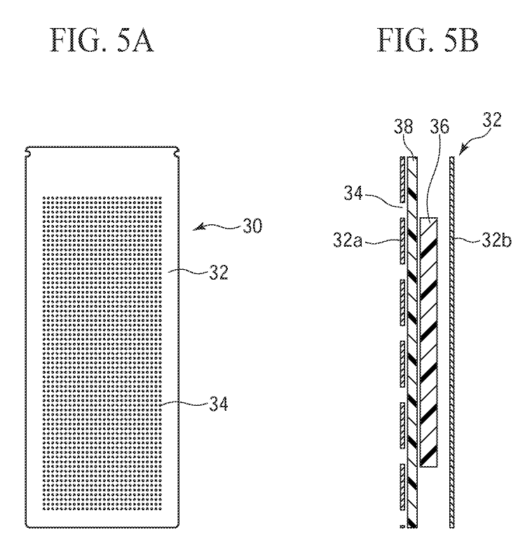

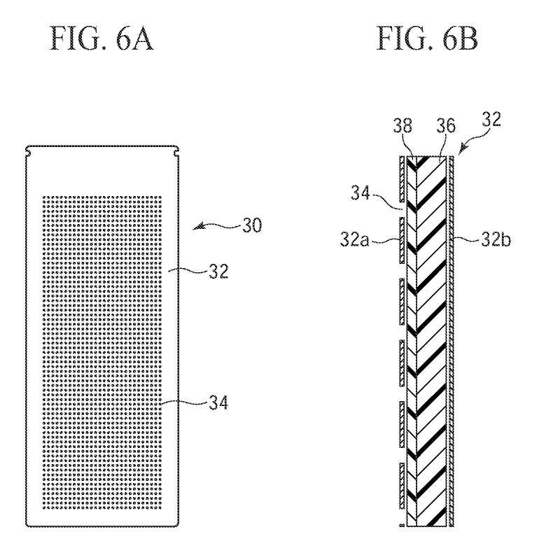

The cartridge for fuel cell and the fuel cell according to one embodiment will be explained with reference to FIGS. 4 to 11. FIG. 4 is a diagrammatic view of the basic structure of a fuel cell system. FIGS. 5A and 5B are a sectional view and a plan view of the cartridge for fuel cell according to the present embodiment (Part 1). FIGS. 6A and 6B are a sectional view and a plan view of the cartridge for fuel cell according to the present embodiment (Part 2).

As illustrated in FIG. 4, the fuel cell system 2 of the present embodiment comprises an air electrode-side housing (a cathode housing) 10; an air electrode collector layer (a cathode collector layer) 12; an air electrode gas diffusion layer 14 disposed adjacent to the air electrode collector layer 12; an air electrode catalytic layer (a positive electrode) 16 disposed adjacent to the air electrode gas diffusion layer 14, for causing a reduction reaction with oxygen as the active material to generate ions; a solid electrolytic layer 18 disposed adjacent to the air electrode catalytic layer 16; a fuel electrode catalytic layer (a negative electrode) 20 disposed adjacent to the solid electrolytic layer 18, for oxidizing the fuel to produce protons and electrons; a fuel electrode gas diffusion layer 22 disposed adjacent to the fuel electrode catalytic layer 20; a fuel electrode collector layer (an anode collector layer) 24 disposed adjacent to the fuel electrode gas diffusion layer 22; a vaporized fuel diffusion layer 26 disposed adjacent to the fuel electrode collector layer 24; and a fuel electrode-side housing (an anode housing) 28 disposed adjacent to the vaporized fuel diffusion layer 26.

In the fuel electrode-side housing 28, a slot 29 for receiving the cartridge for fuel cell 30 is formed. In the slot 29, the cartridge for fuel cell 30 is inserted. The cartridge for fuel cell 30 is removable from the slot 29.

It is necessary that the air electrode collector layer 12 is conductive and highly anticorrosive. To this end, the air electrode collector layer 12 is formed of, e.g., Au-plated stainless (SUS304, SUS316 or others), etc. It is necessary that the air electrode collector layer 12 introduces oxygen in the air into the air electrode catalytic layer 16. To this end, the air electrode collector layer 12 has a structure of mesh, expanded metal, foam or others.

It is necessary that the air electrode gas diffusion layer 14 introduces oxygen in the air into the air poly catalytic layer 16. It is necessary that the air electrode gas diffusion layer 14 also ensures the conduction between the air electrode catalytic layer 16 and the air electrode collector layer 12. To this end, the air electrode gas diffusion layer 14 is formed of, e.g., a porous conductor film, e.g., carbon paper or others. As the carbon paper, carbon paper by, e.g., Toray Industries, Inc. can be used.

The air electrode catalytic layer 16 is formed of a material which is able to generate the electrochemical reaction for producing water from protons (H⁺) and oxygen (O₂). Specifically, the air electrode catalytic layer 16 is formed by mixing a catalyst or a catalyst carrier, and a proton conductive polymer solid electrolyte and applying the mixture to the air electrode gas diffusion layer 14 or the solid electrolytic layer 18. As the air catalytic layer 16, TEC10E50E, which is a platinum carrying catalyst, by Tanaka Kikinzoku Kogyo K.K., for example, can be used.

The solid electrolytic layer 18 is a path for transferring protons generated on the fuel electrode-side to the air electrode-side and is formed of an ion conductor which is not electron conductive. The solid electrolytic layer 18 can be formed of, e.g., perfluorosulfonic acid-based polymer or others can be used. As such perfluorosulfonic acid-based polymer, Nafion (registered trademark), for example, by E.I.du Pont de Nemours and Company can be used. More specifically, as the solid electrolytic layer 18, Nafion N112 can be used.

The fuel electrode catalytic layer 20 is formed by applying, particles of platinum or others, carbon powder and a polymer forming the electrolytic layer to the fuel electrode gas diffusion layer or the solid electrolytic layer. Particles to be applied, for example, to the porous conductor film is not essentially of platinum or others and can be of an alloy of platinum and a transition metal, such as ruthenium or others. As the fuel electrode catalytic layer 20, TEC61E54, for example, which is a platinum-ruthenium alloy carrying catalyst by Tanaka Kikinzoku Kogyo K.K.

It is necessary that the fuel electrode gas diffusion layer 22 introduces the vaporized fuel into the fuel electrode catalytic layer 20. It is necessary that electrical conduction is ensured between the fuel electrode catalytic layer 20 and the fuel electrode collector layer 24. To this end, the fuel electrode gas diffusion layer 22 is formed of a porous conductor film of, e.g., carbon paper or others. As such carbon paper, the carbon paper by, e.g., Toray Industries, Inc. can be used.

It is necessary that the fuel electrode collector layer 24 is conductive and highly anticorrosive. To this end, the fuel electrode collector layer 24 is formed of, e.g., Au plated stainless (SUS304, SUS316 or others), etc. It is necessary that the fuel electrode collector layer 24 introduces the vaporized gas into the fuel electrode catalytic layer 20. To this end, the fuel electrode collector layer 24 has the structure of mesh, expanded metal, foam or others.

The vaporized fuel diffusion layer 26 is for diffusing the vaporized fuel discharged from the cartridge for fuel cell 30. The upper end part of the vaporized fuel diffusion layer 26 is exposed outside out of the housings 10, 28 of the fuel cell system 2. The upper end part exposed out of the housings 10, 28 functions as a carbon dioxide outlet for exhausting the carbon dioxide.

FIGS. 5A and 5B are a plan view and a sectional view of the cartridge for fuel cell according to the present embodiment (Part 1). FIG. 5B is an enlarged sectional view of a part of FIG. 5A. FIG. 5B illustrates the state where the fuel impregnation material disposed in the cartridge case of the cartridge for fuel cell is not impregnated with the fuel.

As illustrated in FIGS. 5A and 5B, the fuel impregnation material 36 is sealed in the cartridge case 32. In one side 32a of the cartridge case 32, a plurality of holes 34 are uniformly formed. No holes 34 are formed in the other side 32b of the cartridge case 32. Between the holes 34 of the cartridge case 32 and the fuel impregnation material 36, a fuel vaporization stabilization layer 38 of a porous material is formed. The fuel vaporization stabilization layer 38, which is formed of a porous material, can homogenously vaporize the fuel and can stably discharge the vaporized fuel. The shape of the holes 34 is, e.g., circular. The diameter of the holes 34 is, e.g., about φ0.1 mm. Total sum of the areas of the holes 34 is about, e.g., 0.07% of an area of the fuel electrode of the fuel cell.

As the porous material forming the fuel vaporization stabilization layer 38, a material which is stable to the aqueous solution of a high concentration of methanol is used. As such material, a porous fluoroplastic material, such as PTFE (Poly Tetra Fluoro Ethylene), PVDF (PolyVinylidene DiFluorie) or others, can be used. The fuel vaporization stabilization layer 38 may be formed of fluoroplastic fiber. The fuel vaporization stabilization layer 38 may be formed of unwoven fabric of carbon fiber, or others.

The size of the fuel impregnation material 36 which is not impregnated with the fuel is set, e.g., at about 20 volume % of the storage capacity of the cartridge case 32. The fuel impregnation material 36 of such size can be prepare by cutting the fuel impregnation material 36 of a large size into a required size. The fuel impregnation material 36 is formed of a polymer material whose volume increases as the material is increasingly impregnated with the fuel. As the polymer material whose volume increases as the fuel more penetrates, a polymer material of a flexible skeleton is used.

As such fuel impregnation material 36, the fuel impregnation material 36 impregnated with the fuel increases the volume by 50% or above of a volume thereof when the fuel impregnation material 36 is not impregnated with the fuel. That is to say, the fuel impregnation material 36 impregnated with the fuel increases the volume by 50% or above of a volume of the fuel impregnation material 36 not impregnated with the fuel. In this specification and the claims, the volume of the fuel impregnation material 36 at the time when impregnated with the fuel does not mean a volume of the fuel impregnation material 36 simply impregnated with the fuel but a volume of the fuel impregnation material 36 sufficiently impregnated with the fuel. More specifically, the volume of the fuel impregnation material 36 impregnated with the fuel means a volume of the fuel impregnation material 36 in the state where the fuel impregnation material 36 is impregnated with the fuel substantially to the maximum.

The fuel impregnation material 36 can be formed of, e.g., a polymer material containing carboxyl groups or sulfone groups can be used. It is necessary that the fuel impregnation material 36 is not dissolvable to the methanol aqueous solution of high concentration. In view of this, as the fuel impregnation material 36, a perfluoro-based polymer material containing carboxyl groups or sulfone groups is especially preferable. As such material, specifically, Nafion (registered trademark), for example, by E.I.du Pont de Nemours and Company can be used. As such nafion film, Nafion N117 (product name), for example, can be used. The fuel impregnation material 36 is not essentially the nafion film by E.I.du Pont de Nemours and Company. For example, Flemion (registered trademark) by Asahi Glass Co., Ltd. may be used as the fuel impregnation material 36. Aciplex (registered trademark), for example, by Asahi Kasei Corporation may be used as the fuel impregnation material 36.

FIG. 6B illustrates the state where the fuel impregnation material 36 is impregnated with the fuel.

As the fuel the fuel impregnation material 36 is impregnated with, a methanol aqueous solution of a methanol concentration of 80 volume % or above. The fuel of such relatively high methanol concentration is used so that the fuel can be discharged in a high concentration.

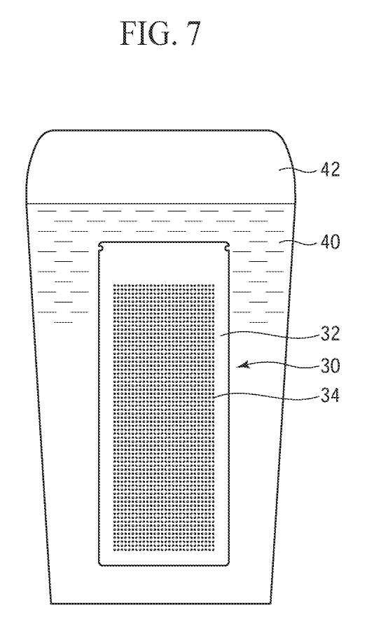

FIG. 7 is a view illustrating the method of penetrating the fuel in the fuel impregnation material of the cartridge for fuel cell (FIG. 7).

As illustrated in FIG. 7, specifically, the cartridge for fuel cell 30 according to the present embodiment is immersed in a storage vessel 42 storing methanol.

Then, the fuel 40 penetrates into the inside space of the cartridge case 32 through the holes 34 formed in one side 32a of the cartridge case 32 of the cartridge for fuel cell 30. The fuel which has penetrated in the space inside the cartridge case 32 penetrates in the fuel impregnation material 36. As the fuel impregnation material 36 is impregnated with the fuel, it increases the volume and has the state illustrated in FIG. 6B.

Next, the application of the fuel cell according to the present embodiment to a portable telephone will be explained by means of an example.

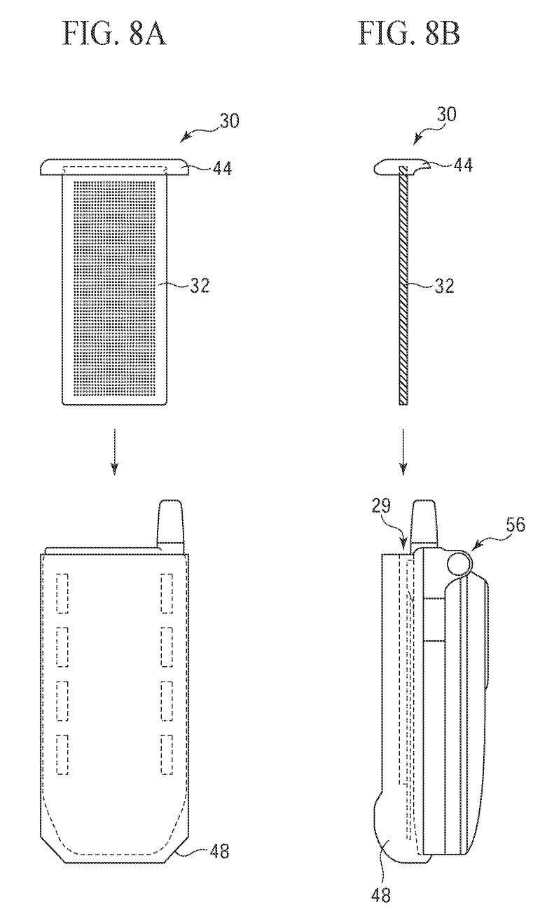

FIGS. 8A to 10B are views of the process of mounting the cartridge for fuel cell according to the present embodiment on the fuel cell part provided on the back of a portable telephone.

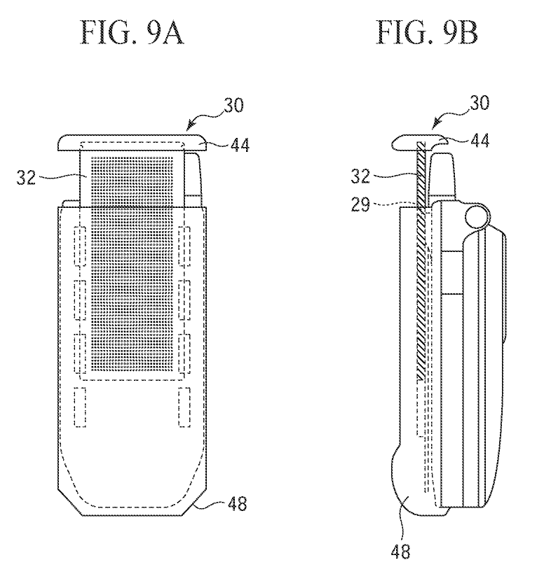

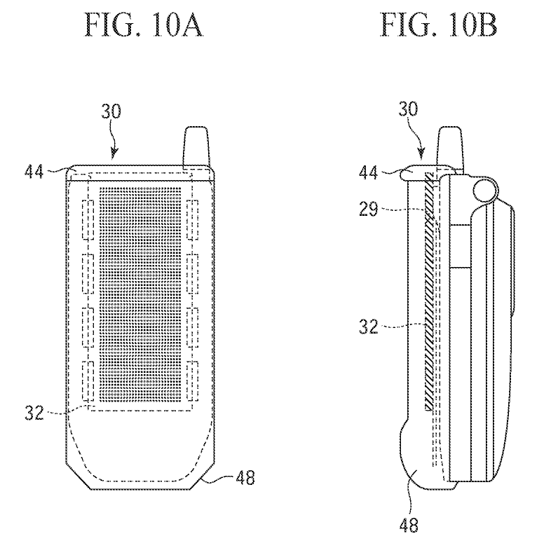

FIGS. 8A and 8B illustrate the cartridge for fuel cell before being mounted on the fuel cell part. FIG. 9 illustrates the cartridge for fuel cell being mounted on the fuel cell part. FIG. 10 illustrates the cartridge for fuel cell mounted on the fuel cell part.

The fuel cell part 48 corresponds to the fuel cell system 2 illustrated in FIG. 3. In the fuel cell part 48 illustrated in FIGS. 8B, 9B and 10B, the left sides of the drawings are the air electrode-side, and the right sides of the drawings are the fuel electrode-side.

As illustrated in FIGS. 8A to 10B, the slot 29 is provided in the fuel cell part 48. The cartridge for fuel cell 30 is removably inserted in the slot 29. A tab 44 is provided on the upper end part of the cartridge case 32 of the cartridge for fuel cell 30. The tab 44 is held with fingers to put on and off the cartridge for fuel cell 30 and also secures the cartridge to the fuel cell part 48 body.

The fuel cell part 48 may be removably mounted on the portable telephone, as is the cradle of the portable telephone or maybe fixed to the back of the portable telephone body.

When power is generated in the fuel cell part 48, the power is charged into the storage cell, such as a lithium cell or others, disposed in the portable telephone 56.

(Evaluation Result)

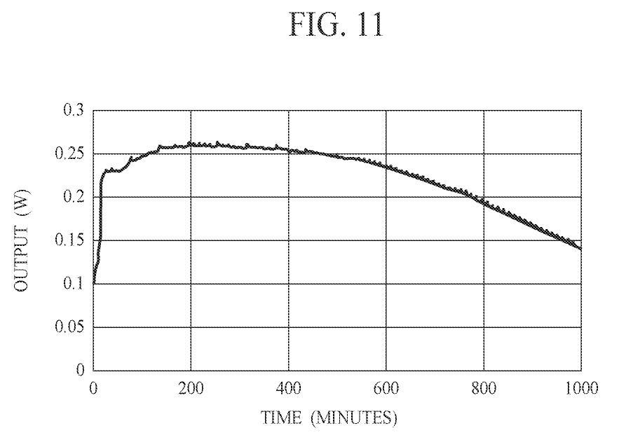

Then, the result of evaluating the cartridge for fuel cell according to the present embodiment will be explained with reference to FIG. 11. FIG. 11 is a graph of the evaluation result of the cartridge for fuel cell according to the present embodiment described above with reference to FIG. 2. More specifically, FIG. 11 is a graph of the output power of the continuous discharge at the constant voltage of 0.37 V. In FIG. 11, time is taken on the horizontal axis, and the output power is taken on the vertical axis.

As seen in FIG. 11, according to the present embodiment, over a very long period of time of 12 hours, outputs of 0.2 W or above were obtained. Based on this, according to the present embodiment, a stable power source can be supplied over a long period of time.

As described above, according to the present embodiment, the fuel impregnation material 36 whose volume sufficiently increases when much impregnated with the fuel than a volume at the time when not impregnated with the fuel is used, whereby as the content of the fuel decreases, the volume of the fuel impregnated material 36 sufficiently decreases. Resultantly, the concentration of the fuel penetrated in the fuel impregnation material 36 is retained in a relatively high concentration. Thus, according to the present embodiment, the cartridge for fuel cell which can stably supply the vaporized fuel can be provided.

(Modifications)

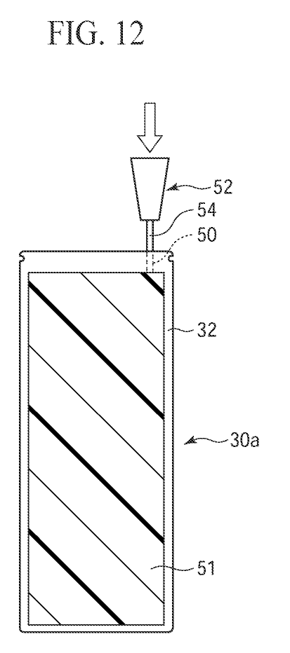

Next, a modification of the cartridge for fuel cell according to the present embodiment will be explained with reference to FIG. 12. FIG. 12 is a view illustrating the method for impregnating the fuel impregnation material of the cartridge for fuel cell with the fuel.

The cartridge for fuel cell 30a according to the present modification is characterized mainly in that an opening 50 is formed for pouring the fuel into the cartridge case 32.

As illustrated in FIG. 12, the opening 50 which arrives at the inside of the cartridge case 32 is formed.

In the cartridge for fuel cell 30a according to the present modification, with the forward end part 54 of a fuel feeder 52 inserted in the opening 50 of the cartridge case 32, the fuel 40 is poured into the cartridge case 32.

While the fuel 40 is pouring into the cartridge case 32, preferably, a tight closure sheet 51 is adhered to one side 32a of the cartridge case 32 so that the vaporized fuel is not discharged through the holes 34 formed in one side 32a of the cartridge case 32.

As described above, it is possible that the opening 50 which arrives at the inside of the cartridge case 32 is formed, and the fuel is poured through the opening 50.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A cartridge for fuel cell for supplying a fuel to a fuel cell, the cartridge for fuel cell comprising:
a cartridge case having a plurality of holes formed at least in one side;
a fuel vaporization stabilization layer formed on the side with said plurality of holes formed in inside the cartridge case; and
a fuel impregnation material sealed inside the cartridge case.

2. A cartridge for fuel cell according to claim 1, wherein
the fuel impregnation material impregnated with the fuel increases the volume by 50% or above of a volume of the fuel impregnation material not impregnated with the fuel.

3. A cartridge for fuel cell according to claim 1, wherein
the fuel impregnation material is formed of a perfluoro-based polymer material containing carboxyl groups or sulfone groups.

4. A cartridge for fuel cell according to claim 1, wherein
the fuel is a methanol aqueous solution of a methanol concentration of 80 volume % or above.

5. A cartridge for fuel cell according to claim 1, wherein
an opening for pouring the fuel into the fuel impregnation material is formed in the cartridge case.

6. A cartridge for fuel cell according to claim 1, wherein
the fuel vaporization stabilization layer is formed of a porous fluoroplastic material, a fluoroplastic fiber or an unwoven fabric of carbon fiber.

7. A fuel cell comprising a power generation part including a fuel electrode, a solid electrolytic layer and an air electrode, and a slot provided in the power generation part on the side of the fuel electrode, for removably receiving a cartridge for fuel cell which discharges vaporized fuel,
the cartridge for fuel cell comprising a cartridge case having a plurality of holes formed in one side, a fuel vaporization stabilization layer formed on the side with said plurality of holes formed in inside the cartridge case, and a fuel impregnation material sealed inside the cartridge case.

8. A fuel cell according to claim 7, wherein
the fuel impregnation material impregnated with the fuel increases the volume by 50% or above of a volume of the fuel impregnation material not impregnated with the fuel.

9. A fuel cell according to claim 7, wherein
the fuel impregnation material is formed of a perfluoro-based polymer material containing carboxyl groups or sulfone groups.

10. A fuel cell according to claim 7, wherein
the fuel is a methanol aqueous solution of a methanol concentration of 80 volume % or above.

11. A fuel cell according to claim 7, wherein
an opening for pouring the fuel into the fuel impregnation material is formed in the cartridge case.

12. A fuel cell according to claim 7, wherein
the fuel vaporization stabilization layer is formed of a porous fluoroplastic material, a fluoroplastic fiber or an unwoven fabric of carbon fiber.

13. A portable telephone comprising a fuel cell including a power generation part including a fuel electrode, a solid electrolytic layer and an air electrode, and a slot provided in the power generation part on the side of the fuel electrode, for removably receiving a cartridge for fuel cell which discharges vaporized fuel,
the cartridge for fuel cell comprising a cartridge case having a plurality of holes formed in one side, a fuel vaporization stabilization layer formed on the side with said plurality of holes formed in inside the cartridge case, and a fuel impregnation material sealed inside the cartridge case.

14. A portable telephone according to claim 13, wherein
the fuel impregnation material impregnated with the fuel increases the volume by 50% or above of a volume of the fuel impregnation material not impregnated with the fuel.

15. A portable telephone according to claim 13, wherein
the fuel impregnation material is formed of a perfluoro-based polymer material containing carboxyl groups or sulfone groups.

16. A portable telephone according to claim 13, wherein
the fuel is a methanol aqueous solution of a methanol concentration of 80 volume % or above.

17. A portable telephone according to claim 13, wherein
an opening for pouring the fuel into the fuel impregnation material is formed in the cartridge case.

18. A portable telephone according to claim 13, wherein
the fuel vaporization stabilization layer is formed of a porous fluoroplastic material, a fluoroplastic fiber or an unwoven fabric of carbon fiber.
